(19) United States
(12) Patent Application Publication
(10) Pub. No.: US 2025/0214321 A1
(43) Pub. Date: Jul. 3, 2025

(54) VEHICLE WINDOW AND VEHICLE COMPRISING SUCH A VEHICLE WINDOW

(71) Applicant: Webasto SE, Stockdorf (DE)

(72) Inventors: Adham AL-SAYYAD, Stockdorf (DE); Wladislaw BRONSTEIN, Stockdorf (DE); Markus POHLEN, Stockdorf (DE); Olivier FARREYROL, Stockdorf (DE)

(21) Appl. No.: 18/991,954

(22) Filed: Dec. 23, 2024

(30) Foreign Application Priority Data
Jan. 3, 2024 (DE) 10 2024 100 118.6

(51) Int. Cl. B32B 17/10; B32B 7/12

(52) U.S. Cl. CPC B32B 17/10036; B32B 7/12; B32B 17/10504; B32B 17/1077; B32B 2305/55; B32B 2307/7375; B32B 2605/00

(57) ABSTRACT

A vehicle window having an outer window pane, an inner window pane, an intermediate layer disposed between the outer window pane and the inner window pane and a switchable layer. The vehicle window may have an opaque masking element disposed laterally next to the intermediate layer, the opaque masking element covering at least a light coupling area of the inner window pane at which light of a light source can be coupled into the inner window pane. Furthermore, a vehicle having such a vehicle window is provided.

### CROSS-REFERENCE TO RELATED APPLICATION

This application claims the benefit of German Application No. 10 2024 100 118.6, filed Jan. 3, 2024, which is incorporated herein by reference in its entirety.

### TECHNICAL FIELD

A vehicle window and a vehicle having such vehicle window.

### BACKGROUND

Vehicle windows are known from practice in various forms.

The known vehicle windows regularly comprise an outer window pane, which faces a vehicle environment, an inner window pane, which faces a vehicle interior, and an intermediate layer. The intermediate layer is disposed between the outer window pane and the inner window pane and comprises a PVB layer.

It is also known from practice for various functional elements to be provided on the outer window pane and/or inner window pane. In order not to negatively affect the visual appearance of the vehicle in this case, cover elements are regularly attached to the vehicle window, which cover the functional elements so that they are not visible when viewed from the vehicle environment and/or when viewed from the vehicle interior.

However, the attachment of the cover elements regularly causes additional assembly steps. Furthermore, there is a risk that the cover elements may come loose over their service life.

### SUMMARY

The object of the present invention is to provide a vehicle window comprising a cover element for covering defined areas which can be easily installed and has a long service life. Furthermore, the object of the present invention is to provide a vehicle comprising a window of this kind.

According to the invention, this object is attained by the vehicle window having the features of claim 1 and the vehicle having the features of claim 15.

So the invention proposes a vehicle window, in particular for a vehicle, comprising an outer window pane facing a vehicle environment, in particular when the vehicle window is installed on the vehicle in a functional manner, an inner window pane facing a vehicle interior, in particular when the vehicle window is installed on the vehicle in a functional manner, a switchable layer, and an intermediate layer disposed between the outer window pane and the inner window pane. An opaque masking element is provided laterally next to the intermediate layer, in particular adjacent to the intermediate layer, the opaque masking element covering, in particular completely, at least a light coupling area of the inner window pane at which light from a light source can be coupled into the inner window pane. So the core idea of the invention is to provide, next to the intermediate layer, an opaque masking element which serves as a cover element and prevents the light coupling area of the inner window pane from being visible from the vehicle environment. The opaque masking element is part of the vehicle window. Consequently, its fixation requires no additional assembly steps and the opaque masking element cannot peel away from neighboring layers.

The opaque masking element extends, for example, from an edge area, in particular from the edge of the vehicle window, towards a center of the vehicle window.

The opaque masking element can have a smaller thickness, i.e., a dimension in a vertical vehicle window direction or orthogonal to a transverse vehicle window plane, than the intermediate layer. Thus, when the individual layers of the vehicle window are fused together, the intermediate layer can enclose the masking element laterally and at least at the top side and/or at the bottom side.

For example, the opaque masking element and the intermediate layer have the same thickness.

In a boundary area in which the opaque masking element adjoins the intermediate layer, the opaque masking element and the intermediate layer are fused together, for example.

The boundary area preferably forms only a small area of the opaque masking element or the intermediate layer, the material of the opaque masking element and the material of the intermediate layer not being mixed in the remaining area.

The intermediate layer is an adhesive layer, for example.

The intermediate layer may be made of or comprise a thermoplastic material.

For example, the intermediate layer comprises polyvinyl butyral (PVB), polyvinyl alcohol (PVA), ethylene-vinyl acetate (EVA) and/or thermoplastic polyurethane (TPU) or is formed from one of the aforementioned materials.

In a preferred embodiment of the vehicle window according to the invention, the intermediate layer is in the form of a PVB layer.

The opaque masking element may be formed of an optically non-conductive material, i.e., be opaque.

For example, the opaque masking element is opaque for wavelengths in the visible range. For this purpose, the opaque masking element may comprise pigments or a died matrix that give it its opaque property. In this case, the opaque masking element may have a light-absorbing effect.

In one embodiment, the masking element is designed to reflect light towards the light coupling area. In this case, the masking element can have a light-reflecting coating.

In an exemplary embodiment, the vehicle window according to the invention comprises another intermediate layer, in particular a PVB layer.

In a preferred embodiment of the vehicle window according to the invention, the switchable layer comprises a PDLC (polymer-dispersed liquid crystal) layer and preferably a PDLC frame circumferentially surrounding the PDLC layer. Preferably, the switchable layer, in particular the PDLC layer, has a seal, a so-called edge seal, on at least one of its lateral edge surfaces.

The switchable layer is formed, for example, by the switchable PDLC layer and the non-switchable PDLC frame.

The PDLC layer comprises two plastic films which are each provided with an electrode layer and between which a PDLC structure is provided.

The PDLC frame can comprise PVB and/or TPU or be formed from one of the aforementioned materials.

For example, the PDLC frame is made of TPU in an area adjacent to a contacting area of the PDLC layer. This reduces the risk of oxidation.

In an exemplary embodiment of the vehicle window according to the invention, the opaque masking element is wider than the PDLC frame. Starting from an edge of the vehicle window, the opaque masking element thus extends further in the direction of a center of the vehicle window than the PDLC frame of the switchable layer.

In a preferred embodiment of the vehicle window according to the invention, the opaque masking element is made of TPU. This prevents plasticizers, in particular those of the PVB or the PVA, from entering the PDLC layer. For example, the intermediate layer is in contact with the inner window pane, while the other intermediate layer, in particular the PVB layer, is in contact with the outer window pane.

The switchable layer can be disposed between the intermediate layer and the other intermediate layer. The switchable layer is thus fixed to the inner window pane and the outer window pane via the intermediate layer and the other intermediate layer, respectively.

The switchable layer can be switchable between a transparent and an opaque or translucent state.

The opaque masking element can be fused with the intermediate layer, the inner window pane and/or the switchable layer, in particular by means of an autoclave process.

The opaque masking element can have at least approximately the same temperature properties as the intermediate layer. It is envisaged that both the masking element and the intermediate layer become ductile during a lamination process for producing the vehicle window, in particular during the fusing; in a particularly advantageous manner, the intermediate layer has a higher ductility than the masking element during lamination. This ensures that the intermediate layer acts as an adhesive layer and that it at least partially melts, while the masking element also softens or becomes ductile compared to usual room temperature and bonds with the inner window pane and/or the intermediate layer during lamination. Preferably, the masking element and the intermediate layer are both preserved in their original form during lamination; in one embodiment, they form no or only a small common phase in terms of volume at their interfaces.

In an exemplary embodiment of the vehicle window according to the invention, the top side and/or bottom side of the opaque masking element are/is adhesive, in particular pressure-adhesive, meaning they or it can be fixed to (an) adjacent layer(s) in particular during production in the course of the negative pressure generated during venting.

In a preferred embodiment of the vehicle window according to the invention, the opaque masking element is connected to the intermediate layer, in particular in points, at its inner side, i.e., at its side facing the intermediate layer, by means of an adhesive or by ultrasonic welding in the course of the production of the vehicle window.

For example, the opaque masking element is connected, in particular in points, to the inner window pane at its bottom side and/or to the switchable layer at its top side by means of an adhesive or by means of ultrasonic welding in the course of the production of the vehicle window. This facilitates a fixing of the masking element when producing the vehicle window.

In an exemplary embodiment of the vehicle window according to the invention, the opaque masking element and the intermediate layer are thus connected to one each other to facilitate the handling of the vehicle window during production.

The opaque masking element can then be fused to the intermediate layer at least at its entire inner side facing the intermediate layer, in particular also on its top side.

In a preferred embodiment of the vehicle window according to the invention, the top side(s) and/or the bottom side(s) of the intermediate layer and/or of the other PVB layer are/is adhesively fixed to adjacent areas of the vehicle window.

In an exemplary embodiment of the vehicle window according to the invention, the top side(s) and/or the bottom side(s) of the intermediate layer and/or of the other PVB layer are/is fixed, in particular in points, that is to say in a plurality of individual spaced points, to an adjacent area of the vehicle window, i.e., the outer window pane, the inner window pane, the opaque masking element and/or the switchable layer, by ultrasonic welding.

In a preferred embodiment, the vehicle window according to the invention comprises a light source.

The light of the light source can be coupled into the inner window pane via the light coupling area.

The light source is disposed, for example, on the light coupling area of the bottom side of the inner window pane facing the vehicle interior.

An optical element, in particular a collimator and/or a coupling element, which is designed to redirect light from the light source in such a manner that the light from the light source is coupled into the inner window pane via the light coupling area primarily in an angular range which corresponds to the angular range of an internal total reflection can be disposed between the light source and the light coupling area. Light in this angular range is primarily guided in the inner window pane by reflection at its window wall.

In an exemplary embodiment of the vehicle window according to the invention, the light source is covered by the opaque masking element in the vertical vehicle window direction. So the opaque masking element and the light source are aligned with each other in the vertical vehicle window direction. The light source is therefore hidden by the opaque masking element, meaning it is not visible from a vehicle environment.

The vertical vehicle window direction corresponds to a vertical vehicle direction vehicle window on the vehicle when the vehicle window is installed on the vehicle in a functional manner.

The inner window pane, the intermediate layer, the outer window pane, the switchable layer and/or the other PVB layer can be laminated together by means of an autoclave in the course of their manufacturing process.

So the vehicle window can be a laminated window, for example.

In an exemplary embodiment of the vehicle window according to the invention, the vehicle window is free of air inclusions.

The vehicle window is vented in the vacuum range in the course of its manufacture, for example, before and/or during the melting of the individual layers.

For venting, the vehicle window can be placed in a vacuum bag in which a vacuum is then generated to remove air inclusions from the vehicle window.

For example, the melting and thus bonding of the individual layers of the vehicle window, in particular in the autoclave, takes place in the same vacuum bag in which the vehicle window was vented.

In a preferred embodiment of the vehicle window according to the invention, a height of the opaque masking element is less than a height of the intermediate layer. Thus, during lamination, the intermediate layer, which is in particular thermoplastic, can enclose the opaque masking element, in particular on the side facing away from the inner window pane.

In an exemplary embodiment of the vehicle window according to the invention, the opaque masking element has a lower elasticity and thus a lower compressibility than the intermediate layer. Thus, when the individual layers of the vehicle window are fused, the intermediate layer can at least partially enclose the opaque masking element.

In a preferred embodiment of the vehicle window according to the invention, the opaque masking element circumferentially surrounds the intermediate layer at least partially, in particular completely.

The opaque masking element can form a closed frame that circumferentially surrounds the intermediate layer.

The opaque masking element is white or black, for example.

In a preferred embodiment of the vehicle window according to the invention, the opaque masking element extends in a transverse vehicle window direction in such a manner that light rays, in particular all light rays, that are coupled into the inner window pane in the light coupling area at such an angle, in particular an angle smaller than the angle of total reflection, that they exit from the inner window pane at the top side strike the opaque masking element.

So the opaque masking element has such a width, for example, that all light rays that are coupled into the inner window pane at an angle of incidence greater than a total reflection angle in the light coupling area strike the opaque masking element when they exit from the inner window pane.

Furthermore, the invention relates to a vehicle, in particular a passenger car, which comprises a vehicle window as described above.

In an exemplary embodiment of the vehicle according to the invention, the vehicle window is part of a vehicle roof.

The vehicle window can be a window of a roof arrangement of a vehicle, in particular a panoramic roof window or a sliding roof window.

For example, the vehicle window is a windshield.

Further advantages and advantageous embodiments of the subject matter of the invention are apparent from the description, the drawing and the claims.

The frame of the invention includes any and all combinations of the features disclosed in the description, the claims and/or the figures, that is to say, each of the features mentioned in the description can be part of the claimed subject matter independently of the other feature mentioned in the respective context.

### BRIEF DESCRIPTION OF DRAWINGS

An exemplary embodiment of a vehicle window according to the invention is shown in the drawing in a schematically simplified manner and is explained in more detail below.

FIG. 1 is a top view of a vehicle roof comprising a vehicle window according to the invention; and

FIG. 2 is a section through the vehicle window of FIG. 1 along line II-II in FIG. 1.

### DETAILED DESCRIPTION

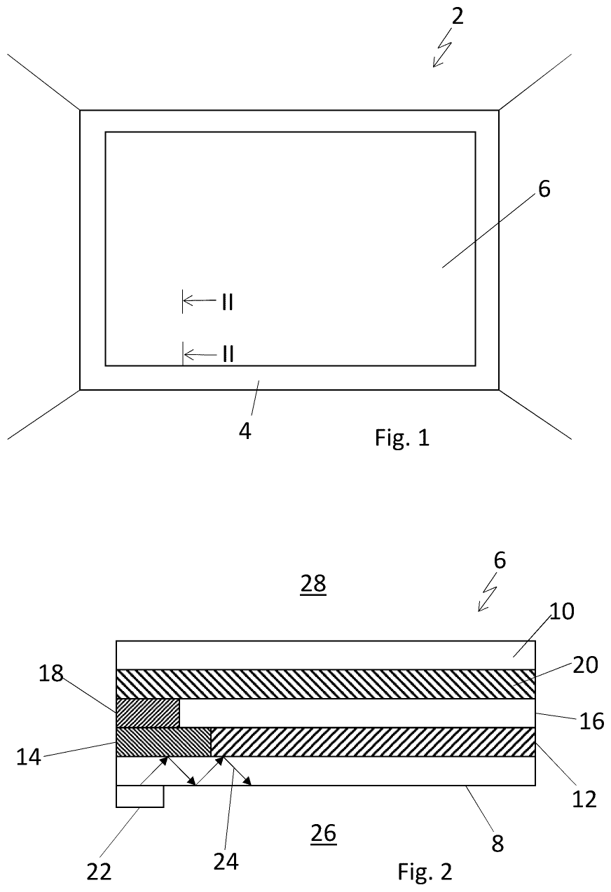

FIG. 1 shows a vehicle roof 2 of a passenger car according to the invention. The vehicle roof comprises a vehicle window 6. The vehicle window 6 is rigidly or immovably attached to a vehicle window frame 4 that is fixed to the body. In particular, the vehicle window 6 is a panoramic roof window.

It is also conceivable that the vehicle window 6 is flexibly attached to the vehicle window frame 4 fixed to the body and can be moved between a state in which the vehicle roof is open and a state in which the opening is closed.

As can be seen from the sectional view in FIG. 2, the vehicle window 6 is a laminated window, which comprises an inner window pane 8, an intermediate layer 12 disposed on the inner window pane 8, an opaque masking element 14 disposed on top of the inner window pane 8 and laterally adjoining the intermediate layer 12, a switchable layer disposed on top of the intermediate layer 12 and the opaque masking element 14, another PVB layer 20 disposed on top of the switchable layer, and an outer window pane 10 disposed on top of the other PVB layer 20. The inner window pane 8 faces a vehicle interior 26, while the outer window pane 10 faces a vehicle environment 28.

When producing the vehicle window 6, the individual layers of the vehicle window 6 are stacked and then fused in an autoclave to form a laminated window. Adjacent layers can be bonded to each other to facilitate the handling of the vehicle window 6 during production.

Before the individual layers of the vehicle window 6 are fused, air inclusions, which may be present between the individual layers, for example, are removed from the vehicle window 6. For this purpose, the unfused vehicle window 6 is introduced into a vacuum container. A vacuum is then generated in this vacuum container. The unfused vehicle window 6 then remains in the vacuum container and is introduced into an autoclave for fusing.

The intermediate layer 12 is formed by a PVB layer. The intermediate layer 12 is circumferentially surrounded by the opaque, i.e., at least partially non-transparent, masking element 14, which in particular forms a closed frame. The opaque masking element 14 also lies flat on the inner window pane 8 at its bottom side. The opaque masking element 14 and the intermediate layer 12 together cover the inner window pane 8, in particular its entire surface.

It is also conceivable that the opaque masking element 14 does not circumferentially enclose the intermediate layer 12 completely but is instead only provided in an area that is aligned with a light coupling area of the inner window pane 8 in the vertical vehicle direction.

To facilitate handling of the vehicle window 6 during the manufacturing process, the opaque masking element 14 and the intermediate layer 12 are connected to each other in points by ultrasonic welding at least for a defined time. So the opaque masking element 14 is welded to the outer side of the intermediate layer 12 on its inner side.

It is also conceivable to connect the opaque masking element 14 and the intermediate layer 12 by means of an adhesive instead of ultrasonic welding, in particular during the manufacturing process.

The fact that the opaque masking element 14 and the intermediate layer 12 are connected only in points and not across their entire surface allows air pockets to escape during venting.

In a finished state, the opaque masking element 14 is fused to the intermediate layer 12 at least on its entire inner side facing the intermediate layer 12, in particular also on its top side.

The bottom sides of the intermediate layer 12 and/or of the opaque masking element 14 are/is (each) adhesive, so they can be fixed to the inner window pane 8 directly or via the opaque masking element 14 or the intermediate layer 12 by being placed on top of the inner window pane 8 and/or a force acting on them from one of the neighboring layers, which can result in particular from a negative pressure resulting from venting.

The switchable layer disposed on the top side of the intermediate layer 12 and of the opaque masking element 14 lies flat on their entire surface.

The switchable layer has a PDLC layer 16 which is circumferentially surrounded by a PDLC frame 18. The PDLC layer 16 can be switched between an opaque state and a transparent state and can thus serve as a kind of sun protection.

Starting from an edge of the vehicle window 6, the PDLC frame 18 has a smaller width, i.e. it extends less towards the center of the vehicle window 6, than the opaque masking element 14, in particular in the transverse vehicle window direction or in the longitudinal vehicle window direction, which correspond to a transverse vehicle direction or a longitudinal vehicle direction when the vehicle window 6 is installed on the vehicle in a functional manner.

In the vertical vehicle window direction, the PDLC frame 18 is flush with the opaque masking element 14. So the PDLC frame 18 is completely covered by the opaque masking element 14 when viewed from the vehicle interior 26 and is therefore not visible to a vehicle occupant located in the vehicle interior 26.

The opaque masking element 14 and the intermediate layer 12 are each adhesive at their top side, which faces the switchable layer. The switchable layer can thus be easily attached to the opaque masking element 14 and the intermediate layer 12.

It is also conceivable that the top side of the intermediate layer 12, but not the top side of the opaque masking element 14, is adhesive. The opaque masking element 14 can thus be connected to the switchable layer via the intermediate layer 12.

The other PVB layer 20, which is disposed flat on top of the switchable layer, covers the entire surface of the switchable layer. In turn, the outer window pane 10 rests on the top side of the other PVB layer 20 in such a manner that it covers the entire surface of the other PVB layer 20.

The bottom side and top side of the other PVB layer 20 form an adhesion when fused, in particular during the lamination process. So, the PVB layer 20 is adhesive by head activation. Thus, the switchable layer can be easily connected to the outer window pane 10 by means of the PVB layer 20 during the production of the vehicle window 6.

A light source 22 is provided in the light coupling area on the bottom side of the inner window pane 8. For example, the light source 22 is fixed to the inner window pane 8 by means of a light coupling element (not shown), through which light rays 24 of the light source 22 can be coupled into the inner window pane 8.

The opaque masking element 14 is disposed in the transverse vehicle window direction in such a manner that the light source 22 is not visible when viewed from the vehicle environment 28. So the light source 22 is aligned with the opaque masking element 14 in the vertical vehicle window direction, the opaque masking element 14 being at least as wide or wider than the light source 22 to ensure complete concealment of the light source 22 as viewed from the vehicle environment 28.

### REFERENCE SIGNS

2 vehicle roof
4 vehicle window frame
6 vehicle window
8 inner window pane
10 outer window pane
12 intermediate layer
14 opaque frame
16 PDLC layer
18 PDLC frame
20 other PVB layer
22 light source
24 light ray
26 vehicle interior
28 vehicle environment

1. A vehicle window, comprising:
an outer window pane,
an inner window pane,
a switchable layer and an intermediate layer disposed between the outer window pane and the inner window pane,
wherein an opaque masking element is disposed laterally next to the intermediate layer,
the opaque masking element covering at least a light coupling area of the inner window pane at which light of a light source can be coupled into the inner window pane.

2. The vehicle window according to claim 1, wherein the opaque masking element is made of TPU.

3. The vehicle window according to claim 1, wherein the intermediate layer is one of a PVB layer or a TPU layer.

4. The vehicle window according to claim 1, wherein the opaque masking element has at least approximately the same temperature properties as the intermediate layer.

5. The vehicle window according to claim 1, wherein the top side and/or the bottom side of the opaque masking element are/is adhesive and/or the opaque masking element is connected to the intermediate layer in points at its inner side by an adhesive or by ultrasonic welding.

6. The vehicle window according to claim 1, wherein the switchable layer lies flat on the top side of the intermediate layer and/or on the opaque masking element in a vertical vehicle window direction, and/or in that the vehicle window comprises another PVB layer, which lies flat on the top side of the switchable layer in the vertical vehicle window direction.

7. The vehicle window according to claim 1, wherein the switchable layer comprises a PDLC layer and a PDLC frame circumferentially surrounding the PDLC layer.

8. The vehicle window according to claim 7, wherein the opaque masking element is wider than the PDLC frame.

9. The vehicle window according to claim 1, comprising a light source whose light can be coupled into the inner window pane in the light coupling area via a light coupling element.

10. The vehicle window according to claim 9, wherein the masking element covers the light coupling area at the top in the vertical vehicle window direction.

11. The vehicle window according to claim 1, wherein the height of the opaque masking element is less than a height of the intermediate layer.

12. The vehicle window according to claim 1, wherein a compressibility of the opaque masking element is less than a compressibility of the intermediate layer.

13. The vehicle window according to claim 1, wherein the opaque masking element circumferentially surrounds the intermediate layer at least partially.

14. The vehicle window according to claim 1, wherein the opaque masking element extends in a transverse vehicle window direction in such a manner that light rays that are coupled into the inner window pane in the light coupling area at such an angle that they exit from the inner window pane at the top side strike the opaque masking element.

15. A vehicle comprising a vehicle window according to claim 1.

16. The vehicle window according to claim 1, wherein the opaque masking element circumferentially surrounds the intermediate layer completely.
